(19) United States
(12) Patent Application Publication
(10) Pub. No.: US 2005/0228100 A1
(43) Pub. Date: Oct. 13, 2005

(54) Talc filled polymer blend having metallic effect

(75) Inventors: Mir L. Ali, Bryan, OH (US); Johnny D. Jaggers, Stryker, OH (US); Stuart Dorsky, Bryan, OH (US); David E. Barnum, Stryker, OH (US); Yvonne D. Vold, Bryan, OH (US); James J. Bal, Maumee, OH (US)

Correspondence Address: RANKIN, HILL, PORTER & CLARK, LLP, 925 EUCLID AVENUE, SUITE 700, CLEVELAND, OH, 44115-1405, US

(73) Assignee: Ferro Corporation, Cleveland, OH (US)

(21) Appl. No.: 10/823,381

(22) Filed: Apr. 13, 2004

(51) Int. Cl. C08K 3/08; C08K 3/34

(52) U.S. Cl. 524/439; 524/451

(57) ABSTRACT

The present invention provides a new and improved polymer blend that displays a high metallic effect and is capable of being utilized in elevated temperature applications comprising from about 3% to about 12% by weight metal particles component, from about 30% to about 60% by weight talc and from about 35% to about 70% by weight olefinic polymer. The metal particles component comprises aluminum particles having an undefined configuration and an average particle size of from about 200 μm to about 400 μm.

### FIELD OF INVENTION

The present invention concerns a polymer blend for use in producing molded and extruded plastic parts. More particularly, the present invention concerns a talc filled polymer blend having a high metallic effect or appearance for use in high temperature environments.

### BACKGROUND

Polymer blends containing metal particles are known in the prior art. Examples of metal filled polymer blends produced from color concentrates are taught in U.S. Pat. Nos. 6,646,038 and 6,194,507.

U.S. Pat. No. 6,646,038 concerns color concentrates and blends made therefrom using aluminum particles of an undefined configuration and an average particle size of from about 75 μm to about 150 μm. Molded or extruded products made in accordance with the teachings of the '038 patent display a high metallic effect.

U.S. Pat. No. 6,194,507 concerns color concentrates and blends made therefrom using aluminum particles that have both a spherical and a lenticular shape with an average particle size of from about 20 μm to about 75 μm. Molded or extruded products made in accordance with the teachings of the '507 patent display a matte metallic effect.

Products made in accordance with the '507 and '038 patents yield products with high metal content, good metal and pigment dispersibility and distribution. However, such products are not useful in applications wherein the products will experience a high temperature environment, for such products do not contain meaningful loadings of talc. Elevated temperatures will tend to degrade the physical properties of products made under the teachings of the '507 and '038 patents. In order to withstand elevated operating environments, a polymer blend is generally filled with significant amounts of talc (over 30%). Unfortunately, the metal systems disclosed in the '507 and '038 patents will not provide a meaningful metallic effect in heavily loaded talc filled polymer blends that are suitable for high temperature applications.

### SUMMARY OF INVENTION

The present invention provides a new and improved polymer blends for use in producing finished products that display a high metallic effect and that can withstand high temperature environments, such as, the engine compartment of an automobile. These products are filled with more than 30% by weight talc.

A polymer blend made in accordance with the present invention comprises by weight from about 3% to about 12% metal particles component, from about 30% to about 60% talc, and from about 35% to about 70% olefinic thermoplastic polymer. The metal component comprises aluminum particles having an undefined configuration and an average particle size of from about 200 μm to about 400 μm. The polymer blend may also include one or more pigments, generally in the range by weight of from about 0% to about 10%.

These and other aspects of the present invention will become clear to those skilled in the art upon the reading and understanding of the specification and the claims below.

### DETAILED DESCRIPTION

Polymer blends made in accordance with the present invention yield various advantages. These advantages include: (i) the production of finished parts that have good dispersion and distribution of the metal particles; (ii) the production of finished parts that display a significant metallic look or effect that is noticeable in even low light conditions (e.g., in an office or within a house); and (iii) the absence of knit lines and flow lines upon molding of the polymer blend. The formation of knit lines is avoided because the metal particles do not pile up into a vertical orientation during molding. Additionally, knit lines are avoided because there is no agglomeration of metal particles within the thermoplastic polymer. Moreover, the polymer blends of the present invention contain significant loadings of talc, and thus they are suitable for use in making finished parts for use in high temperature environments, including but not limited to, under the hood of an automobile or truck, or the inside of an appliance, such as the inside of a dishwasher or clothes washing machine.

A polymer blend made in accordance with the present invention includes a base resin made from one or more olefinic polymers. Waxes are not used in the present invention because of their negative effect upon the physical properties of the final product. Thus, the polymer blend of the present invention comprises less than 3% by weight wax.

The olefinic polymers suitable for use in the present invention include, for example, polymers and copolymers of A¹-olefins such as polyethylene, polypropylene, polybutene, poly-4-methyl pentene-1, propylene/ethylene copolymers and copolymers of 4-methyl pentene-1 with linear A¹-olefins containing 4 to 18 carbon atoms. Whatever polymer system is utilized, it may be supplied in either powder or pellet form. The polymer blend comprises by weight from about 35% to about 70% olefinic polymer. Preferably, the blend comprises by weight from about 35% to about 65% by weight olefin.

The metal particles component ofthe present invention comprises aluminum particles having an average particle size in the range of from about 200 μm to about 400 μm having an undefined configuration. The undefined configuration and the particle size distribution have been found to be critical relative to the formation of a product with a significant metallic effect. Undefined configuration means aluminum particles that display neither a spherical nor a lenticular configuration. The undefined particles have a very irregular shape. Metal particles suitable for use in the present invention may be purchased from the Obron Atlantic Corporation of Painesville, Ohio, or Siberline of Tamaqua, Pa. It will be appreciated that for some applications additional metal particles having an average particle size in excess of 400 μm may be included in blends of the present invention to enhance the metallic effect or appearance of the polymer blend. Such additional metal particles may even comprise large flakes that are commonly known as “glitter.”

A critical component of the polymer blend is talc. Without the presence of significant talc in the blends, they will not display heat resistant properties and good flexural properties. The talc may have an average particle size of from about 1 μm to about 5 μm.

The polymer blend may comprise any one or more of a number of commercially available colors or pigments so as to provide the described color effect in the concentrate and the thermoplastic polymer that is to be colored. As used in this specification and claims below “colorant material” means any conventional inorganic or organic pigment or organic dyestuff. Such materials are described, for example, in Kirk-Othmer Encyclopedia of Chemical Technology, Third Edition, Vol. 6, pp. 597-617, which is incorporated herein by reference. Examples of inorganic pigments include, for example, titanium dioxide, iron oxide, zinc chromate, cadmium sulfides, chromium oxides and sodium aluminum silicate complexes. Examples of organic type pigments include azo and diazo pigments, carbon black, phthalocyanines, quinacridone pigments, perylene pigments, isoindolinone, anthraquinones, thioindigo and solvent dyes.

Various types of additives may also be included in the blend of the present invention. Such additives may include, for example, antioxidants, stabilizers and/or process aids such as alkaline earth metal soaps and carboxylates such as calcium benzoate, calcium octoate and calcium naphthenate, Friedel-Crafts cation progenitor compounds such as zinc oxide, zinc hydroxide, zinc carbonate, zinc acetate, zinc laurate, zinc naphthenate, zinc stearate, zinc oleate, zinc 2-ethyl-hexoate, cadmium oxide, cadmium hydroxide, cadmium carbonate, cadmium acetate, cadmium laurate, cadmium naphtheneate, cadmium stearate, cadmium oleate, cadmium 2-ethyl-hexoate, calcium stearate, aluminum oxide, aluminum hydroxide, aluminum carbonate, aluminum acetate, aluminum chlorolaurate, antimony oxide, antimony hydroxide, antimony carbonate, antimony naphthenate, tin oxide, tin hydroxide, tin carbonate, tin naphthenate, and tin 2-ethyl-hexoate, aliphatic polyhydric compounds such as trimethylolethane, trimethylolpropane, tetramethylolcyclohexanol, pentaerythritol, dipentaerythritol, and tripentaerythritol and tri-(2-hydroxyethyl) iso-cyanurate (THEIC). Waxes may be included, but at levels of less than 3% by weight of the color concentrate so as not to detrimentally affect the properties and molding characteristics of the uncolored thermoplastic polymer. Examples of such waxes include paraffins, castor oil waxes and ethylene bis-stearamide.

Various types of fillers and/or reinforcers may also be included in the concentrate at levels up to 10% by weight of the blend. Such fillers and/or reinforcers include, for example, CaCO₃, barium sulfate, glass, clay and mica.

The portions of polymeric resin, talc, colorant material and metal particles component may vary. Generally, when producing the blend, the mixture utilized comprises from about 35 to about 70 weight percent olefinic polymer, from about 3 to about 12 weight percent metal particles component, from about 30 to about 60 weight percent talc and from about 0 to about 10 weight percent colorant material. The mixture may comprise up to 3 weight percent additives. Preferably, the mixture comprises from about 40 to about 65 weight percent olefinic polymer, from about 5 to about 11 weight percent metal particles component, from about 40 to about 55 weight percent talc and from about 0 to about 5 weight percent colorant material.

The blend may be formed in a single-step process. It is imperative that the mixing be low intensity and low shear in nature so as not to alter the particle size of the aluminum particles. In some applications it may be desirable to prepare a premix of the various components in a mixer such as a Papenmeir mixer, a Waring blender or a Henschel mixer. A low speed of, for example, 2-8 meters per second is preferred. Mineral oil or other liquid wetting agents may be added in minor amounts to the mix to help prevent dusting. The mix may then be fed to a melt mixer such as a single or twin screw extruder having a very low shear screw.

The polymer blend may be formed into any desired physical form for subsequent processing into a molded or shaped article. It will be recognized by one skilled in the art, however, that for most molding and/or shaping processes, pellets of the polymer blend are most advantageous for accommodating most molding and shaping apparatuses or processes, e.g., injection molding, extrusion molding or shaping and the like.

The blend compositions made in accordance with the present invention may be utilized to prepare a variety of different molded or shaped articles by various molding and shaping processes. For example, such molded articles as bottles, closures, automotive parts, toys, furniture and cabinet parts and the like. These molded articles may be prepared by such processes as injection molding, rotational molding, sheet extrusion, film extrusion, thermoforming and the like. For example, closures, toys and furniture parts may be prepared by injection molding.

A representative composition falling within the scope of the present invention is illustrated in the following example. While this example will show one skilled in the art how to operate within the scope of this invention, the example is not to serve as a limitation on the scope of the invention for such scope is defined only in the claims. It is pointed out that in the following example, and elsewhere in the present specification and claims, all percentages and all parts are intended to express percent by weight and parts by weight unless otherwise clearly indicated.

### EXAMPLE I

The polymer blend was formed by feeding the components set forth below to a single screw Maddox mixer at 120 RPM using a moderate shear screw. The aluminum particles were added downstream of the other components.

| Component | Weight % |
|---|---|
| Talc Filled Polypropylene¹ | 89.80 |
| Aluminum Particles² | 6.80 |
| Aluminum Particles³ | 2.95 |
| Additives⁴ | 0.45 |

¹Commercially available polypropylene blend comprising 40% by weight talc, 0.075% by weight zinc stearate and 0.025% by weight zinc dibutyldilithiocarbamate.
²A premix containing 20% by weight mineral oil and 80% by weight aluminum particles having an average particle size of about 225 μm. The premix is available from Eckart of Louisville, Kentucky under the trade designation Mastersafe 225203.
³premix comprising 30% by weight olefin and 70% by weight aluminum particles having an average particle size of about 330 μm and an undefined configuration. The premix is available from Silberline under the trade designation LIVET 420-30-E1.
⁴Commercially available antioxidants.

### Physical Properties

Physical Properties

| | | |
|---|---|---|
| Tensile Strength | ASTM D-638 | 2905 |
| (psi) - 2 inch per minute | | |
| Elongation at Yield (%) | ASTM D-790 | 6.2 |
| Flexural Modulus | ASTM D-790 | 534 |
| Young's Modulus - 0.2 kpsi/minute | | |
| Flexural Strength | ASTM D-790 | 5008 |
| (psi) - 0.2 inch/minute | | |
| Izod Impact (ft - lb/inch) | ASTM D-256 | .81 |
| Notched @ 23° C. | | |

Although the invention has been shown and described above with respect to specific embodiments, it is obvious that equivalent alterations and modifications will occur to others skilled in the art upon reading and understanding the specification. The present invention includes all such equivalent alterations and modifications, and is limited only by the scope of the following claims.

1. A polymer blend for use in producing plastic articles having a metallic effect appearance for high temperature applications comprising by weight from about 3% to about 12% metal particles component, from about 30% to about 60% talc, and from about 35% to about 70% olefinic thermoplastic polymer, said metal particle component comprising aluminum particles having an undefined configuration and an average particle size of from about 200 μm to about 400 μm.

2. A polymer blend as set forth in claim 1 wherein said olefinic thermoplastic polymer comprises a homopolymer or copolymer of polypropylene.

3. A polymer as set forth in claim 1 wherein said blend comprises from about 40 to about 55 weight percent talc.

4. A polymer as set forth in claim 1 wherein said blend comprises from about 40 to about 65 weight percent olefinic polymer.

5. A polymer as set forth in claim 1 wherein said blend comprises from about 5 to about 11 weight percent metal particles component.

6. A polymer blend as set forth in claim 1 wherein said talc has an average particle size of from about 1 μm to about 5 μm.

7. A polymer blend as set forth in claim 1 wherein said blend includes up to about 5 percent by weight colorant.
